(19) United States
(12) Patent Application Publication
(10) Pub. No.: US 2024/0176641 A1
(43) Pub. Date: May 30, 2024

(54) APPARATUS AND METHOD FOR EXECUTING DIGITAL TWIN

(71) Applicant: ELECTRONICS AND TELECOMMUNICATIONS RESEARCH INSTITUTE, Daejeon (KR)

(72) Inventors: Seung Woog JUNG, Daejeon (KR); Hyun Chul KANG, Daejeon (KR); Min Gi KIM, Daejeon (KR); Ji Yeon SON, Daejeon (KR); Young Seog YOON, Daejeon (KR); Yong Kwi LEE, Daejeon (KR); Eun Seo LEE, Daejeon (KR); Hark Jin LEE, Daejeon (KR); Young Ae CHUN, Daejeon (KR)

(21) Appl. No.: 18/244,412

(22) Filed: Sep. 11, 2023

(30) Foreign Application Priority Data
Nov. 25, 2022 (KR) 10-2022-0160863
Feb. 28, 2023 (KR) 10-2023-0027308

(51) Int. Cl. G06F 9/455

(52) U.S. Cl. CPC G06F 9/45558; G06F 2009/45562

(57) ABSTRACT

An apparatus and method for executing a digital twin is provided. The apparatus includes a generation module configured to generate first to Nth digital twin Docker images by combining first to Nth digital twin models, where assets are virtualized, and first to Nth Docker images, respectively, wherein each of the digital twin Docker images includes the corresponding digital twin model and a file required for executing the corresponding digital twin model (N being a natural number greater than 1), an authoring module configured to author a digital twin workflow by connecting the first to Nth digital twin Docker images, a scheduling module configured to select a target digital twin Docker image to be currently executed from the digital twin workflow, and schedule execution of the selected target digital twin Docker image, and an execution module configured to execute the target digital twin Docker image according to the scheduling result.

### CROSS-REFERENCE TO RELATED APPLICATIONS

This application claims priority to and the benefit of Korean Patent Application No. 10-2022-0160863 and 10-2023-0027308, filed on Nov. 25, 2022 and Feb. 28, 2023, respectively, the disclosure of which is incorporated herein by reference in its entirety.

### BACKGROUND

### 1. Field of the Invention

The present disclosure relates to an apparatus and method for executing a digital twin, and more particularly, to an apparatus and method for executing a digital twin model in which manufacturing assets are virtualized.

### 2. Description of Related Art

A digital twin is an intelligent convergence technology of analyzing, in a virtual world, various pieces of information collected from a real world, deriving an optimization plan, and optimizing the real world on the basis of the optimization plan. That is, the digital twin is a technology of copying machines, equipment, objects, or the like in the real world with a computer to generate a digital virtual twin, and simulating situations that may occur in the real world, to predict the situations in advance, and may be referred to as an interface capable of understanding past and current operating states and predicting future operations by combining pieces of data and information representing structures, contexts, and operations of various physical systems.

Meanwhile, efforts are being made to perform simulation and situation prediction for a manufacturing site by modeling various assets such as facilities, processes, lines, and legacy manufacturing systems existing in the manufacturing site as a digital twin, and for example, the Asset Administration Shell (AAS) has been proposed as a standard method for modeling various assets in manufacturing sites.

Various manufacturing assets such as facilities, processes, lines, and legacy manufacturing systems exist in manufacturing sites, and in order to provide various services such as artificial intelligence, simulation, and monitoring systems on the basis of the various manufacturing assets, a system capable of handling processes from modeling a digital twin for the assets to executing the digital twin is required. Furthermore, in order to apply the digital twin to the various manufacturing sites, a mechanism is required to develop the digital twin and flexibly and consistently execute the digital twin.

The background are of the present disclosure is disclosed in Korean Patent Application Publication No. 10-2022-0022446 (published on Feb. 25, 2022).

### SUMMARY OF THE INVENTION

The present disclosure is directed to providing an apparatus and method for executing a digital twin, capable of effectively executing a digital twin for manufacturing assets such as facilities, processes, lines, and the like by interworking the digital twin with the manufacturing assets, machine learning, simulation, and legacy systems, applying the digital twin to various manufacturing sites, and executing the digital twin flexibly and consistently.

An apparatus for executing a digital twin according to some embodiments of the present disclosure includes a generation module configured to generate first to Nth digital twin Docker images by combining first to Nth digital twin models, in which assets are virtualized, and first to Nth Docker images, respectively, wherein each of the digital twin Docker images includes the corresponding digital twin model and a file required for executing the corresponding digital twin model (where N is a natural number greater than or equal to 2), an authoring module configured to author a digital twin workflow by connecting the first to Nth digital twin Docker images, a scheduling module configured to select a target digital twin Docker image to be currently executed from the digital twin workflow, and schedule execution of the selected target digital twin Docker image, and an execution module configured to execute the target digital twin Docker image according to the scheduling result of the scheduling module.

In some embodiments of the present disclosure, the authoring module may author the digital twin workflow in a method that connects inputs and outputs of the first to Nth digital twin Docker images.

In some embodiments of the present disclosure, Mth and Kth digital twin models respectively included in Mth and Kth digital twin Docker images, which are interconnected in the digital twin workflow, may have the same parameter as configuration parameters thereof (where, M and K are natural numbers greater than or equal to 1 and less than or equal to N, and M≠K).

In some embodiments of the present disclosure, the Mth digital twin model may have a specific parameter as an output parameter, the Kth digital twin model may have the specific parameter as an input parameter, and the authoring module may author the digital twin workflow in a method that connects the output parameter of the Mth digital twin model and the input parameter of the Kth digital twin model.

In some embodiments of the present disclosure, when the target digital twin Docker images correspond to the Mth and Kth digital twin Docker images, the execution module may sequentially execute the Mth and Kth digital twin Docker images.

In some embodiments of the present disclosure, the authoring module may author the digital twin workflow in the form of a directed acyclic graph (DAG).

In some embodiments of the present disclosure, each of the digital twin Docker images may be configured to be distributed and executed over a plurality of computing nodes, and when the digital twin Docker images are distributed and executed over the computing nodes, the scheduling module may monitor an execution state of the digital twin Docker image at each computing node to determine a target computing node for executing the target digital twin Docker image.

In some embodiments of the present disclosure, the scheduling module may identify available resources of each computing node based on a result of monitoring the execution state of the digital twin Docker image in each computing node, determine a required resource required when the target digital twin Docker image is executed, and determine a computing node securing available resource above the determined required resource as the target computing node.

In some embodiments of the present disclosure, the asset may indicate at least one of a facility, a process, a line, and a legacy manufacturing system in a manufacturing site.

A method of executing a digital twin according to some embodiments of the present disclosure includes generating, by a generation module, first to Nth digital twin Docker images by combining first to Nth digital twin models, in which assets are virtualized, and first to Nth Docker images, respectively, wherein each of the digital twin Docker images includes the corresponding digital twin model and a file required for executing the corresponding digital twin model (where N is a natural number greater than or equal to 2), authoring, by an authoring module, a digital twin workflow by connecting the first to Nth digital twin Docker images, scheduling, by a scheduling module, execution of a target digital twin Docker image to be currently executed from the digital twin workflow, and executing, by an execution module, the target digital twin Docker image according to the scheduling result of the scheduling module.

### BRIEF DESCRIPTION OF THE DRAWINGS

The above and other objects, features, and advantages of the present disclosure will become more apparent to those of ordinary skill in the art by describing exemplary embodiments thereof in detail with reference to the accompanying drawings, in which:

FIG. 1 is a block diagram illustrating an apparatus for executing a digital twin according to an embodiment of the present disclosure;

FIGS. 2 and 3 are exemplary diagrams illustrating a digital twin model in the apparatus for executing a digital twin according to the embodiment of the present disclosure;

FIG. 4 is an exemplary diagram illustrating a digital twin workflow in the apparatus for executing a digital twin according to the embodiment of the present disclosure;

FIG. 5 is a block diagram illustrating an operation of a scheduling module of the apparatus for executing a digital twin according to the embodiment of the present disclosure; and

FIG. 6 is a flowchart illustrating a method of executing a digital twin according to an embodiment of the present disclosure.

### DETAILED DESCRIPTION OF EXEMPLARY EMBODIMENTS

Hereinafter, embodiments of an apparatus and method for executing a digital twin according to the present disclosure will be described with reference to the accompanying drawings. In this process, the thickness of lines or the size of components illustrated in the drawings may be exaggerated for clarity and convenience of description. In addition, the terms to be described below are defined in consideration of functions in the present disclosure, which may vary depending on the intention of a user or operator, or custom. Therefore, the definitions of the terms should be based on contents throughout this specification

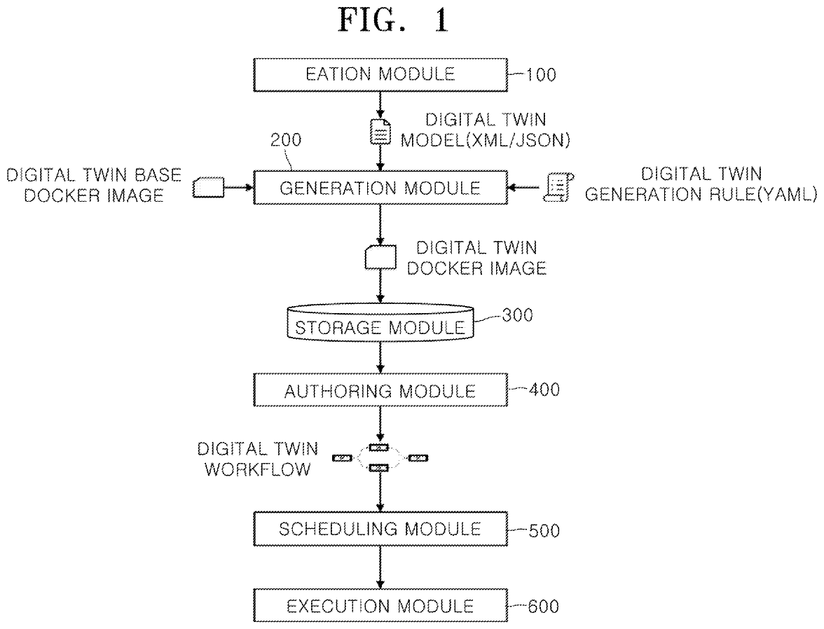

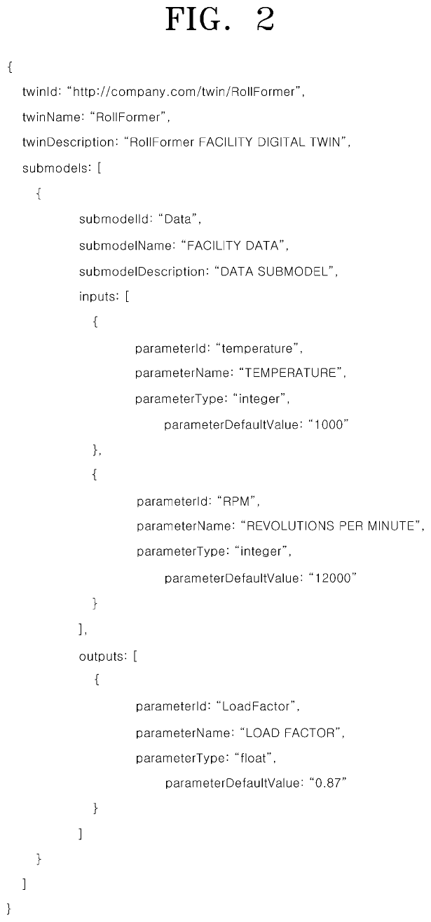

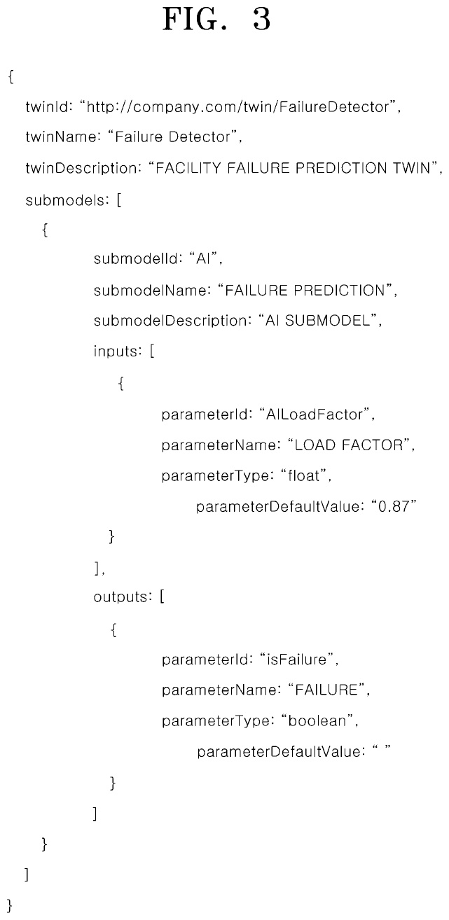

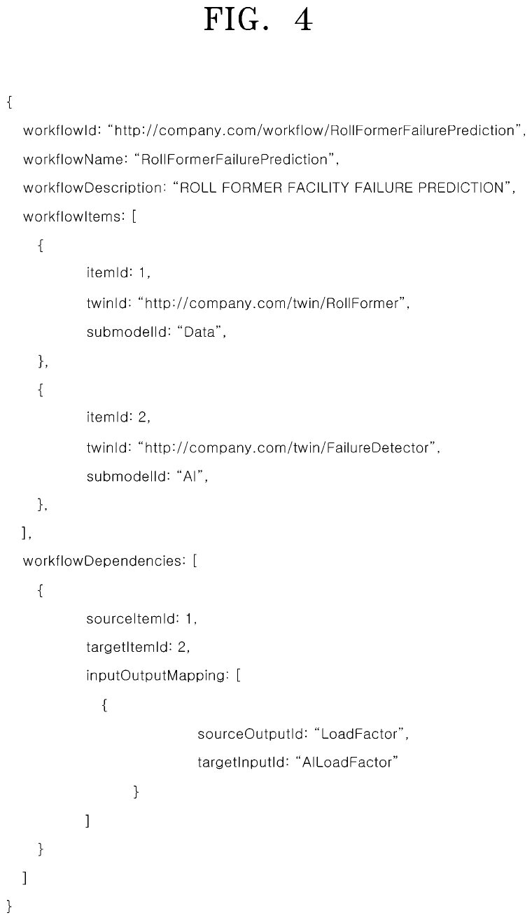

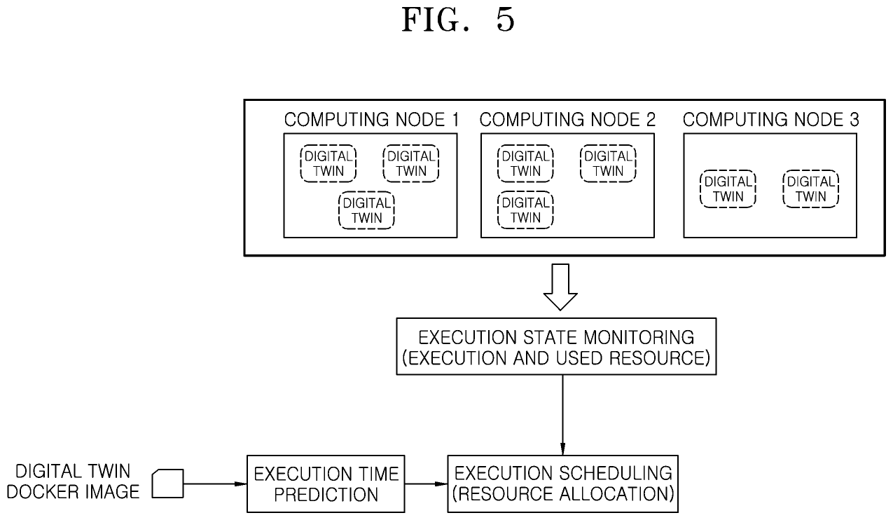

FIG. 1 is a block diagram illustrating an apparatus for executing a digital twin according to an embodiment of the present disclosure, FIGS. 2 and 3 are exemplary diagrams illustrating a digital twin model in the apparatus for executing a digital twin according to the embodiment of the present disclosure, FIG. 4 is an exemplary diagram illustrating a digital twin workflow in the apparatus for executing a digital twin according to the embodiment of the present disclosure, and FIG. 5 is a block diagram illustrating an operation of a scheduling module of the apparatus for executing a digital twin according to the embodiment of the present disclosure.

Referring to FIG. 1, the apparatus for executing a digital twin according to the present embodiment includes a creation module 100, a generation module 200, a storage module 300, an authoring module 400, a scheduling module 500, and an execution module 600.

The creation module 100 creates a digital twin model in which assets are virtualized on the basis of asset information collected from the assets. In the present embodiment, the assets may correspond to manufacturing assets such as facilities, processes, lines, legacy manufacturing systems, artificial intelligence systems, simulation systems, or monitoring systems existing in a manufacturing site. The creation module 100 may provide a user with a user interface (UI) for creating the digital twin model, and may create the digital twin model in the format of XML or JavaScript Object Model (JSOM) based on a user's operational input of manufacturing asset information (e.g., temperature, operating state, load factor, fault information, and the like of facility) collected from the manufacturing assets.

When the structure of the digital twin model is described in detail with reference to FIGS. 2 and 3, the digital twin model includes a digital twin identifier (twinId), a digital twin name (twinName), a digital twin description (twinDescription), and one or more submodels. The submodels include a submodel identifier (submodelId), a submodel name (submodelName), a submodel description (submodelDescription), a plurality of input parameters (inputs), and a plurality of output parameters (outputs). The input parameters include an input parameter identifier (parameterId), an input parameter name (parameterName), an input parameter type (parameterType), an input parameter default value (parameterDefaultValue), and similarly, the output parameters include an output parameter identifier (parameterId), an output parameter name (parameterName), an output parameter type (parameterType), and an output parameter default value (parameterDefaultValue).

FIG. 2 illustrates an example of the digital twin model of a JavaScript Object Notation (JSON) format, in which “RollFormer” is virtualized as a facility. As shown in FIG. 2, a digital twin model of RollFormer has a Data submodel. The Data submodel has a temperature and the number of revolutions per minute as the input parameter, and has a load factor as the output parameter.

FIG. 3 illustrates an example of the digital twin model of a JSON format in which “FailureDetector” is virtualized as an artificial intelligence (AI) system. As shown in FIG. 3, a FailureDetector digital twin model has an AI submodel. The AI submodel has a load factor as the input parameter, and a failure determination result as the output parameter.

The creation module 100 may create a plurality of digital twin models for each manufacturing asset, and the plurality of digital twin models are denoted as first to Nth digital twin models (where N is a natural number greater than or equal to 2).

The generation module 200 generates first to Nth digital twin Docker images by combining the first to Nth digital twin models created by the creation module 100 and first to Nth Docker images previously generated and stored, respectively.

The term “Docker” refers to a software platform that supports application software to be rapidly built, tested, and deployed. Docker packages the application software into standardized modules called containers, and the containers include everything needed to execute the software, such as libraries, system tools, and code. In addition, Docker includes software as well as an independent execution environment, thereby ensuring flexible and consistent execution even in various different execution environments (operating systems, memory, application tool package versions, and the like). Docker is configured to be executed by Docker images that include all libraries and package files necessary for the execution of the application software.

The present embodiment employs Docker images as the means of executing the digital twin model using the above-described scalability, execution flexibility, and consistency of Docker. As a digital twin Docker image (which may be referred to as a digital twin base Docker image) are generated by combining a digital twin model and a Docker image, the digital twin Docker image includes the digital twin model and all files necessary for the execution of the digital twin model. When generating the digital twin Docker image, a digital twin generation rule written in Ain′t Markup Language (YAML) for coupling, interworking, and compatibility between the digital twin model and the Docker image may be applied. A plurality of digital twin Docker images are generated and stored in the storage module 300.

The authoring module 400 connects the first to Nth digital twin Docker images stored in the storage module 300 to author a digital twin workflow in the form of a directed acyclic graph (DAG).

In this case, the authoring module 400 authors the digital twin workflow in a method that connects inputs and outputs of the first to Nth digital twin Docker images. When two digital twin Docker images to be connected are respectively defined as Mth and Kth digital twin Docker images, and the digital twin models respectively included in the Mth and Kth digital twin Docker images are defined as Mth and Kth digital twin models (where, M and K are natural numbers greater than or equal to 1 and less than or equal to N, and M/K), the authoring module 400 authors the digital twin workflow by connecting an output parameter of the Mth digital twin model and an input parameter of the Kth digital twin model. In this case, as a condition for connecting the Mth and Kth digital twin Docker images, the Mth and Kth digital twin models must have the same parameter as configuration parameters thereof, and specifically, the output parameter of the Mth digital twin model and the input parameter of the Kth digital twin model must have the same specific parameter.

As a specific embodiment, a connection process of the digital twin model of RollFormer in FIG. 2 (corresponding to the Mth digital twin model described above) and the digital twin model of FailureDetector in FIG. 3 (corresponding to the Kth digital twin model described above) will be described.

The authoring module 400 checks an output parameter of the Data submodel of the RollFormer digital twin model and an input parameter of the AI submodel of the FailureDetector digital twin model. Since the output parameter of the Data submodel of the RollFormer digital twin model and the input parameter of the AI submodel of the FailureDetector digital twin model are all load factors and equal, the authoring module 400 authors the digital twin workflow by mutually connecting the output parameter of the Data submodel of the RollFormer digital twin model and the input parameter of the AI submodel of the FailureDetector digital twin model. The authored digital twin workflow performs a function of predicting a failure based on the load factor of the RollFormer facility, and FIG. 4 illustrates an example of the generated digital twin workflow.

The connection of these digital twin Docker images is performed for the first to Nth digital twin Docker images stored in the storage module 300, and the execution order of the digital twin Docker images in the digital twin workflow is specified according to an input and output connection relationship of the digital twin Docker images.

The scheduling module 500 selects a target digital twin Docker image to be currently executed from the digital twin workflow and schedules execution of the selected digital twin Docker image. The term “scheduling” is defined as a concept of allocating resources required for the execution of the target digital twin Docker image. For example, when the execution of the RollFormer digital twin Docker image described above is completed, the scheduling module 500 selects the target digital twin Docker image to be currently executed as the FailureDetector digital twin Docker image according to the execution order specified in the digital twin workflow, and allocates the resources required for the execution of the FailureDetector digital twin Docker image.

In the present embodiment, each digital twin Docker image is configured to be distributed and executed over a plurality of computing nodes (where, a computing node may refer to a single computing device or a group of a plurality of computing device connected through the same network). When a new digital twin Docker image (the target digital twin Docker image described above) is to be executed in the process in which the plurality of digital twin Docker images are distributed and executed over the plurality of computing nodes, it is necessary to select a computing node in which resources required for the execution of the target digital twin Docker image are secured.

Accordingly, when the digital twin Docker image is distributed and executed over the computing nodes, as shown in FIG. 5, the scheduling module 500 monitors the execution state (whether the digital twin Docker image is executed on each computing node, and the resources (CPU, GPU, memory, disk storage, network, and the like) used by the digital twin Docker image being executed) of the digital twin Docker image on each computing node, and identifies available resources of each computing node based on the monitoring result. In addition, the scheduling module 500 determines required resources, which are required when the target digital twin Docker image is executed, based on a size of the target digital twin Docker image and an execution time according to the size. Thereafter, the scheduling module 500 determines the computing node securing available resources above the required resource determined as a target computing node for executing the target digital twin Docker image.

The execution module 600 executes the target digital twin Docker image after allocating the resources for execution of the target digital twin Docker image to the target computing node according to the scheduling result of the scheduling module 500.

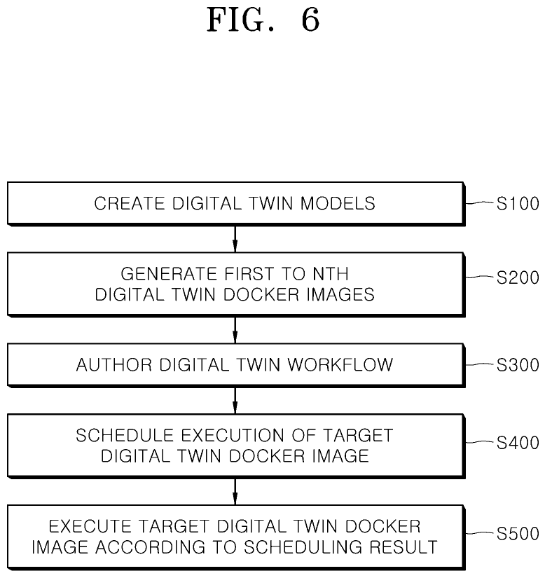

FIG. 6 is a flowchart illustrating a method of executing a digital twin according to an embodiment of the present disclosure. The method of executing a digital twin of the present embodiment will be described with reference to FIG. 6, and a detailed description of parts overlapping with the aforementioned contents will be omitted, and the description will be made focusing on a time series configuration.

First, the creation module 100 creates digital twin models in which manufacturing assets are virtualized on the basis of asset information collected from the assets (S100).

Subsequently, the generation module 200 generates first to Nth digital twin Docker images by combining first to Nth digital twin models created in operation S100 and first to Nth Docker images previously generated and stored, respectively (S200).

Subsequently, the authoring module 400 authors a digital twin workflow in a method that connects inputs and outputs of the first to Nth digital twin Docker images generated in operation S200 (S300).

Subsequently, the scheduling module 500 selects a target digital twin Docker image to be currently executed from the digital twin workflow and schedules execution of the selected digital twin Docker image (S400).

Subsequently, the execution module 600 executes the target digital twin Docker image after allocating resources for the execution of the target digital twin Docker image to a target computing node according to the scheduling result of the scheduling module 500 (S500).

According to the present disclosure, there is an effect of effectively executing a digital twin for manufacturing assets such as facilities, processes, lines, and the like by interworking the digital twin with the manufacturing assets, machine learning, simulation, and legacy systems, and applying the digital twin to various manufacturing sites, to execute the digital twin flexibly and consistently, and a plurality of digital twins may be effectively linked and executed based on a docker technology that ensures a consistent execution environment in different environments.

In addition, according to the present disclosure, the operation and state of physical assets may be optimized by executing an optimization of the physical assets in a Docker environment on the basis of artificial intelligence/machine learning, instead of simply representing the physical asset in a virtual space.

In addition, according to the present disclosure, a production workflow, which operates with a plurality of assets, may be projected as it is into a virtual space by mutually linking a plurality of twins, and a manufacturing digital twin may be maximally adopted and utilized to an industrial site by providing a seamless connection between the assets in a physical space and the manufacturing digital twin in the virtual space and pre-checking and optimizing the operation of a set of assets based on artificial intelligence, machine learning, and simulation in the virtual space.

The term “module”, as used herein, may include a unit implemented as hardware, software, or firmware, for example, the term “module” may be interchangeably used with the term a “logic”, a “logical block”, a “component”, or a “circuit”. The “module” may be an integrally formed component, a minimum unit of the component performing one or more functions, or a part of the minimum unit. For example, according to one embodiment, the “module” may be implemented in the form of an application-specific integrated circuit (ASIC). Further, implementations described herein may be implemented in, for example, a method or process, a device, a software program, a data stream, or a signal. Although discussed only in the context of a single form of implementation (e.g., discussed only as a method), implementations of the discussed features may also be implemented in other forms (e.g., as a device or program). The device may be implemented as suitable hardware, software, firmware, or the like. The method may be implemented by a device such as a processor, which generally refers to a processing device, including, for example, a computer, a microprocessor, an integrated circuit or programmable logic device, or the like. The processor also includes communication devices such as computers, cellular phones, portable/personal digital assistants (PDAs), and other devices that facilitate communication of information between end-users.

According to an apparatus and method for executing a digital twin according to the present disclosure, there is an effect of effectively executing a digital twin for manufacturing assets such as facilities, processes, lines, and the like by interworking the digital twin with the manufacturing assets, machine learning, simulation, and legacy systems, and applying the digital twin to various manufacturing sites to execute the digital twin flexibly and consistently, and a plurality of digital twins can be effectively linked and executed based on a docker technology that ensures a consistent execution environment in different environments.

In addition, according to the present disclosure, the operation and state of physical assets can be optimized by executing an optimization of the physical assets in a Docker environment on the basis of artificial intelligence/machine learning, instead of simply representing the physical asset in a virtual space.

In addition, according to the present disclosure, a production workflow, which operates with a plurality of assets, can be projected as it is into a virtual space by mutually linking a plurality of twins, and a manufacturing digital twin can be maximally adopted and utilized to an industrial site by providing a seamless connection between the assets in a physical space and the manufacturing digital twin in the virtual space and pre-checking and optimizing the operation of a set of assets based on artificial intelligence, machine learning, and simulation in the virtual space.

Although the embodiments of the present disclosure have been described with reference to the drawings, it would be understood that they are merely examples and various modifications and equivalents thereof may be made by one of ordinary skill in the art. Accordingly, the technical scope of the present disclosure should be defined in the appended claims.

What is claimed is:

1. An apparatus for executing a digital twin, the apparatus comprising:
a generation module configured to generate first to Nth digital twin Docker images by combining first to Nth digital twin models, in which assets are virtualized, and first to Nth Docker images, respectively, wherein each of the digital twin Docker images includes the corresponding digital twin model and a file required for executing the corresponding digital twin model, where N is a natural number greater than or equal to 2;
an authoring module configured to author a digital twin workflow by connecting the first to Nth digital twin Docker images;
a scheduling module configured to select a target digital twin Docker image to be currently executed from the digital twin workflow, and schedule execution of the selected target digital twin Docker image; and
an execution module configured to execute the target digital twin Docker image according to the scheduling result of the scheduling module.

2. The apparatus of claim 1, wherein the authoring module authors the digital twin workflow in a method that connects inputs and outputs of the first to Nth digital twin Docker images.

3. The apparatus of claim 2, wherein Mth and Kth digital twin models respectively included in Mth and Kth digital twin Docker images, which are interconnected in the digital twin workflow, have the same parameter as configuration parameters thereof, where M and K are natural numbers greater than or equal to 1 and less than or equal to N, and M≠K.

4. The apparatus of claim 3, wherein the Mth digital twin model has a specific parameter as an output parameter,
the Kth digital twin model has the specific parameter as an input parameter, and
the authoring module authors the digital twin workflow in a method that connects the output parameter of the Mth digital twin model and the input parameter of the Kth digital twin model.

5. The apparatus of claim 4, wherein, when the target digital twin Docker images correspond to the Mth and Kth digital twin Docker images, the execution module sequentially executes the Mth and Kth digital twin Docker images.

6. The apparatus of claim 2, wherein the authoring module authors the digital twin workflow in the form of a directed acyclic graph (DAG).

7. The apparatus of claim 1, wherein each of the digital twin Docker images is configured to be distributed and executed over a plurality of computing nodes, and
when the digital twin Docker images are distributed and executed over the computing nodes, the scheduling module monitors an execution state of the digital twin Docker image at each computing node to determine a target computing node for executing the target digital twin Docker image.

8. The apparatus of claim 7, wherein the scheduling module identifies available resources of each computing node based on a result of monitoring the execution state of the digital twin Docker image in each computing node, determines a required resource required when the target digital twin Docker image is executed, and determines a computing node securing available resource above the determined required resource as the target computing node.

9. The apparatus of claim 1, wherein the asset indicates at least one of a facility, a process, a line, and a legacy manufacturing system in a manufacturing site.

10. A method of executing a digital twin, the method comprising:
generating, by a generation module, first to Nth digital twin Docker images by combining first to Nth digital twin models, in which assets are virtualized, and first to Nth Docker images, respectively, wherein each of the digital twin Docker images includes the corresponding digital twin model and a file required for executing the corresponding digital twin model, where N is a natural number greater than or equal to 2;
authoring, by an authoring module, a digital twin workflow by connecting the first to Nth digital twin Docker images;
scheduling, by a scheduling module, execution of a target digital twin Docker image to be currently executed from the digital twin workflow; and
executing, by an execution module, the target digital twin Docker image according to the scheduling result of the scheduling module.
